(19) United States
(12) Patent Application Publication
(10) Pub. No.: US 2006/0041734 A1
(43) Pub. Date: Feb. 23, 2006

(54) Associating mac addresses with addresses in a look-up table

(76) Inventors: Swee Hock Lim, Singapore (SG); Hak Keong Sim, Singapore (SG)

Correspondence Address: SLATER & MATSIL LLP, 17950 PRESTON ROAD, SUITE 1000, DALLAS, TX, 75252, US

(21) Appl. No.: 10/519,665

(22) PCT Filed: Jul. 1, 2002
(86) PCT No.: PCT/SG02/00147

§ 371 Date: Dec. 29, 2004

(51) Int. Cl. G06F 12/10

(52) U.S. Cl. 711/206

(57) ABSTRACT

An ethernet switch associates addresses in a look-up table with received MAC addresses using a CRC algorithm, so that correspondence data about each MAC address can be stored in the corresponding section of the look-up table. When, as the look-up table is constructed, a given MAC address A₀ hashes to an address H₀ which is already associated with a previous MAC address, the MAC address is re-hashed using Walsh codes W_{1,m} to provide a different look-up table address H₁. This procedure can be performed any number of times y to generate different addresses Hₙ for n=1, . . . y. If it is performed sufficiently frequently, then it is likely that an address will be found which is free. In this way, the number of MAC addresses which will typically be associated with a single look-up table address is reduced, preferably to only one.

### FIELD OF THE INVENTION

The present invention relates to methods of associating MAC addresses with addresses in a look-up table. The invention further relates to a switch such as an ethernet switch employing the method.

### BACKGROUND OF THE INVENTION

Each computer on a LAN (local area network), such as an ethernet LAN, has a unique address called a MAC (media access control) address. An Internet switch which is connected to various computers of the LAN through its different respective switch ports, needs to learn the MAC address associated with each switch port, and may additionally store other data pertaining to each of these MAC addresses. It does this by defining a look-up table in RAM, so that each MAC address is associated with an address in the look-up table (here referred to as a “look-up table address”). The look-up table needs to store at each address the correspondence data for each MAC address which becomes associated with that address. This correspondence data includes the MAC address itself, and also data which is to be stored about that MAC address (e.g. the port with which the computer having that MAC address is associated). The MAC address alone is 48-bits wide, so a large RAM is needed to define the look-up table.

The association of MAC addresses with addresses in the look-up table proceeds by an automatic algorithm. Clearly, the RAM cannot be so large as to have a number of look-up table addresses equal to the total number of possible MAC addresses (i.e. 2 to the power of 48). Therefore, a correspondence is defined between MAC addresses and memory location, and for this a process known as “hashing” is used. “Hashing” refers to the process of mapping the 48-bit MAC address to a shorter look-up table address using a compression algorithm, such as a Cyclic Redundancy Code (CRC) algorithm to reduce the 48-bit addresses to X bits, where X is the number of bits defining an address in the look-up table. Typically X is 9 or 10.

Often more than one of the computers attached to a single switch will be mapped by the hashing to the same look-up table address. Hence, the RAM will have to have a large enough memory capacity to store, at each look-up table address, all the correspondence data which may have to be stored for each of the MAC addresses which might be mapped to that look-up table address. In other words, the memory requires a large “width” for each look-up table address. This is despite the fact that, while there may be a few addresses in the look-up table which are mapped to several MACs of the LAN, there will typically be a very large number of look-up table addresses which are not mapped to any MAC addresses. In other words, there is an inefficiency. The implication is that there is an unnecessary increase of the memory size. A possible solution to this problem is provided by using content-addressable memory, but this is both costly and complex, so a simpler solution is desirable.

### SUMMARY OF THE INVENTION

The present invention seeks to alleviate at least partially the problems described above.

In general terms, the present invention proposes that when, as the look-up table is constructed, a given MAC address hashes to a look-up table address which is already occupied (i.e. there is already a MAC address associated with that look-up table address), the MAC address is re-hashed to provide a different look-up table address. This procedure can be performed any number of times. If it is performed sufficiently frequently, then it is likely that an address will be found which is free. In this way, the number of MAC addresses which will typically have to be associated with a single look-up table address is reduced, preferably to only one.

Specifically, a first expression of the invention is a method of associating look-up table addresses with MAC addresses, the method including for successive MAC addresses A₀:

using A₀ to generate y+1 look-up table addresses H₀, H₁, H₂, . . . , H_{y}, where y is an integer greater than or equal to one; and

according to at least one criterion, associating the address A₀ with a selected one of the addresses H₀, H₁, H₂, . . . , H_{y}.

The criterion may, for example, be that A₀ is associated with Hₙ where n is the smallest integer in the range 0 to y such that there is presently no MAC address associated with the address Hₙ, or more generally such that the number of MAC addresses presently associated with the address Hₙ is less than a predetermined integer.

The addresses H₁ to H_{y} are preferably generated successively, upon it being determined that the previously generated address fails to meet the criterion. For example, Hₙ₊₁ may be generated only in the case that it is found that Hₙ does not meet the criterion.

The value of y may be predetermined, such that the maximum number of addresses H₀, H₁, H₂, . . . , H_{y} which are generated is no more than a predetermined integer, even if none of these addresses meets the criterion. In this case a second criterion may be used to select which of the addresses H₀, H₁, H₂, . . . , H_{y} is associated with the address A₀.

Alternatively, the value of y may be unlimited, and the method may generate addresses continually until at least one is found which meets the criterion.

Each of the addresses H₁, H₂, . . . , H_{y} is preferably obtained from the address A₀ by the following steps. Firstly, we forming a respective string Sₙ having the same number of bits as A₀ (according to present technology, 48). These Sₙ may just be respective sections of A₀ and in this case we optionally select one Sₙ (say S₁) and XOR it component-by-component with each of the other y−1 Sₙ, so that each of the other y−1 Sₙ is modified. Then each Sₙ (or modified Sₙ) is modulated with a respective set of Walsh codes (of the kind widely used in CDMA encoding for example). The y resultant strings are used in the same CRC which transformed A₀ to H₀, to produce Hₙ. Due to the use of Walsh codes, the likelihood is higher of the Hₙ for different MAC addresses A₀ being different from each other.

In a second aspect, the invention provides an Ethernet switch which performs a method according to the invention.

Specifically, this aspect of the invention may be expressed as an switch including a memory for defining a look-up table having a plurality of addresses and a processor for associating MAC addresses with addresses of the look-up table,

the processor being arranged to use each MAC address A₀ to generate y+1 look-up table addresses H₀, H₁, H₂, . . . , H_{y} for y an integer greater than or equal to one, and according to at least one criterion to associate the address A₀ with a selected one of the addresses H₀, H₁, H₂, . . . , H_{y}.

Naturally, the various preferred features of the method are also preferred features of the switch.

### BRIEF DESCRIPTION OF THE FIGURES

An embodiment of the invention will now be described in detail for the sake of example only, with reference to the following figures in which:

FIG. 1 shows schematically the ways the embodiment uses a 48-bit MAC address to form four different look-up table addresses;

FIG. 2 shows an algorithm for constructing a look-up table in the embodiment; and

FIG. 3 shows an algorithm for retrieving data from a look-up table formed by the algorithm of FIG. 2.

### DETAILED DESCRIPTION OF THE EMBODIMENT

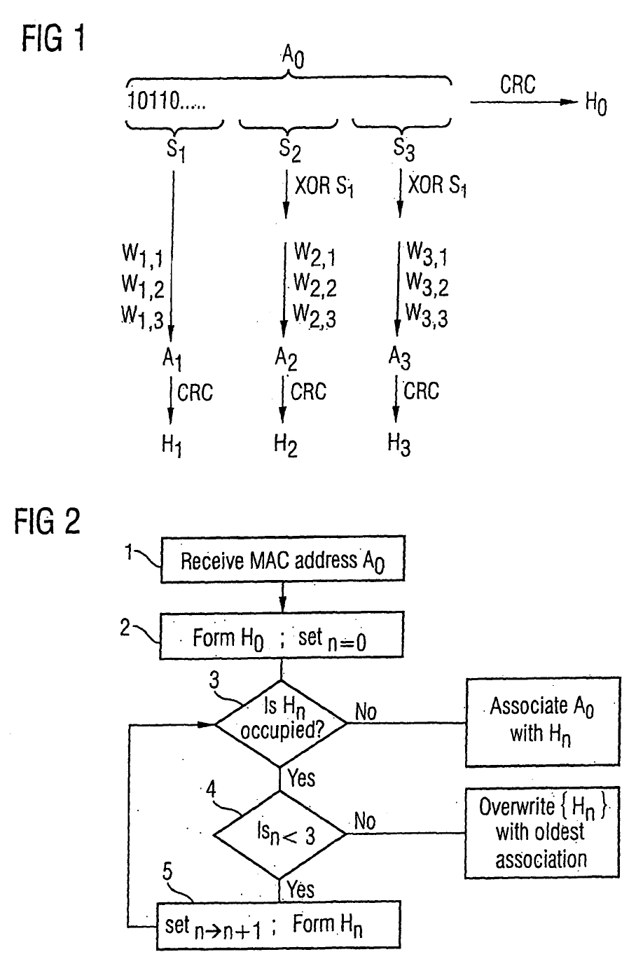

The method used by the embodiment to generate multiple look-up table addresses from a single MAC code is illustrated schematically in FIG. 1. The 48-bit MAC address is there called A₀. A₀ can be hashed by a known CRC to form an address of any desired number of bits (typically 9 or 10 bits). The MAC address for A₀ generated in this way is referred to here as look-up table address H₀.

The embodiment proposes that 3 alternative look-up table addresses may be created. The first is formed from the first 16 bits of the 48-bit MAC address, S₁. The second is formed from the second 16 bits of the 48-bit MAC address, S₂. The third is formed from the final 16 bits of the 48-bit MAC address, S₃. Generally, these 16-bit strings are referred to here as Sₙ, for integer n=1, . . . , 3. S₂ and S₃ are then preferably modified by XORing them, component-by-component with S₁.

Each of the 16-bit strings Sₙ is then used to generate a corresponding 48 bit string Aₙ, n=1, . . . , 3 by spreading/modulating the corresponding string Sₙ by using a respective code which is formed as a 16-bit concatenation of 3 different 16-bit Walsh codes. The nine 16-bit Walsh codes are written W_{n,m} n=1, . . . 3, m=1, . . . 3. The first three 3 components of Aₙ are formed by an XOR of the first component of Sₙ with the first three components of W_{n,1} respectively. Similarly, the second three components of Aₙ are formed by an XOR of the second component of Sₙ with the second three components of W_{n,1} respectively. And so on. The sixth three components of Aₙ are formed by XORing the sixth component of Sₙ by the last component of W_{n,1} and the first two components of W_{n,2.} And so on.

The same CRC is then used to generate a look-up table address Hₙ for each of these strings Aₙ.

The algorithm by which a new MAC address A₀ is added to the look-up table is illustrated in FIG. 2, and has the following steps.

In step 1, the address A₀ is received.

In step 2, the address A₀ is hashed by the CRC to form look-up table address H₀, and the integer variable n is set to 0.

In step 3, it is determined if the look-up table address Hₙ is already occupied. If the answer is “no”, then the MAC address A₀ can be associated with the address Hₙ and the algorithm terminates.

If the answer at step 3 is “yes”, the algorithm determines in step 4 if n is less than 3.

If the answer is “yes”, then in step 5 the algorithm increases n by 1, forms Hₙ, and then returns to step 3.

If the answer is “no” then the algorithm terminates. No free addresses have been found at any of H₀, H₁, H₂, or H₃. In this case, the algorithm finds the one of the addresses out of H₀, H₁, H₂ and H₃ for which the association with its MAC address was formed furthest into the past, deletes this association, and associates A₀ with that address. In this way, as new MAC addresses are received each new address always becomes associated with a look-up table address which is not presently occupied, but sometimes old MAC addresses lose their association with any entry of the look-up table.

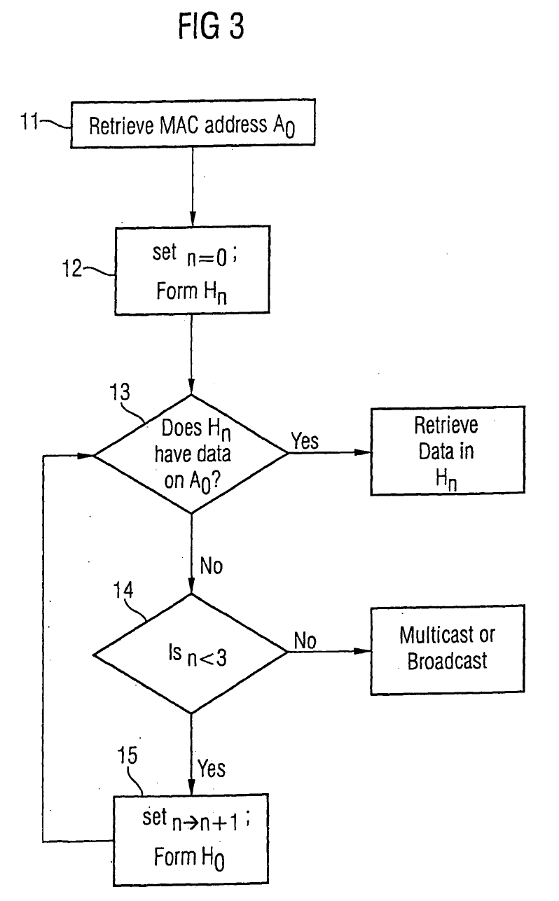

FIG. 3 shows an algorithm for extracting information about a certain MAC address from a look-up table generated by the embodiment.

In a first step 11 a MAC address A₀ is received.

In step 12 the integer variable n is set to 0, and the same CRC is used to generate a first look-up table address Hₙ.

In step 13, it is determined whether the look-up table address Hₙ is associated with the MAC address A₀ (this can be done by examining the correspondence data at address Hₙ in the look-up table). If the answer is “yes” then the required information is extracted from the address Hₙ, and the algorithm terminates.

If the answer is “no”, the algorithm proceeds to step 14 in which it is verified whether n is less than 3. If no, then the algorithm has failed to find any look-up table address associated with A₀. In this case, the system may proceed in any of the ways which are known in the prior art in comparable circumstances. For example, if information is to be transmitted to a computer with the MAC address A₀, that information may be multicast (i.e. transmitted through a group of the ports) or broadcast (i.e. transmitted through all of the ports), in order that it should reach that computer.

If the answer is “yes” the algorithm proceeds to step 15 in which n is set to n+1, W_{n,1}, W_{n,2} and W_{n,3} are used to generate Aₙ, and the CRC is used to generate look-up table address Hₙ from Aₙ. After this the algorithm returns to step 13.

Although the invention has been explained above with reference to a single embodiment. Many variations of this algorithm are possible within the scope of the invention as will be clear to a skilled reader.

As a first example, although the algorithm has been shown trying just four look-up table addresses, this can be generalised to y addresses (i.e. the algorithm above illustrates the special case of y=3). There are various ways in which the 48-bit MAC address A₀ can be used to generate y different addresses Hₙ, n=1, . . . , y as will be clear to a skilled reader. The only way in which FIGS. 2 and 3 need be varied in this case is that the test at steps 4 and 14 becomes whether n is less than y.

As a second example, although the use of Walsh codes is preferred there are many ways in which a 16-bit string Sₙ can be converted into a 48-bit string Aₙ, and indeed many ways in which strings Aₙ can be generated without using strings Sₙ, as will be clear to a skilled reader.

As a third example, although the invention has been shown in FIG. 2 terminating when the number of look-up table addresses found to be occupied is 3, in principle the algorithm may keep on generating new look-up table addresses until a certain criterion is fulfilled, e.g. that an unoccupied look-up table address is found with which the present MAC address can be associated.

1. A method of associating look-up table addresses with media access control (MAC) addresses, the method including for successive MAC addresses A₀:
using A₀ to generate y+1 look-up table addresses H₀, H₁, H₂, . . . , H_{y}, where y is an integer greater than or equal to one, wherein each of the addresses H₁, H₂, . . . , H_{y} is obtained from the address A₀ by first forming a respective string A₀ having the same number of bits as A₀, and then applying the algorithm by which H₀ is obtained from A₀; and
according to at least one criterion associating the address A₀ with a selected one of the addresses H₀, H₁, H₂, . . . , H_{y}.

2. A method according to claim 1 wherein the criterion is that A₀ is associated with Hₙ where n is the smallest integer in the range 0 to y such that there is presently no MAC address associated with the address Hₙ.

3. A method according to claim 1 wherein the criterion is that A₀ is associated with Hₙ where n is the smallest integer in the range 0 to y such that the number of MAC addresses associated with the address Hₙ is less than a predetermined integer.

4. A method according to claim 1 wherein the addresses H₁ to H_{y} are generated successively upon it being found that the preceding Hₙ does not meet a criterion.

5. A method according to claim 4 wherein the value of y is predetermined, whereby the maximum number of addresses H₀, H₁, H₂, . . . , H_{y} which are generated is no more than a predetermined number, even if none of these addresses meets the criterion.

6. (canceled)

7. A method according to claim 1 wherein each Aₙ is obtained by modulating a string Sₙ obtained by a selection from A₀ with a respective set of Walsh codes.

8. A switch including a memory for defining a look-up table having a plurality of addresses and a processor for associating MAC addresses with addresses of the look-up table, the processor being arranged to use each MAC address A₀ to generate y+1 look-up table addresses H₀, H₁, H₂, . . . , H_{y} for y an integer greater than or equal to one, wherein each of the addresses H₁, H₂, . . . , H_{y} is obtained from the address A₀ by first forming a respective string An having the same number of bits as A₀, and then applying the algorithm by which H₀ is obtained from A₀, and according to at least one criterion to associate the address A₀ with a selected one of the addresses H₀, H₁, H₂, . . . , H_{y}.

9. A method according to claim 2 wherein the addresses H₁ to H_{y} are generated successively upon it being found that the preceding Hₙ does not meet a criterion.

10. A method according to claim 8 wherein the addresses H₁ to H_{y} are generated successively upon it being found that the preceding Hₙ does not meet a criterion.

11. A method according to claim 3 wherein the addresses H₁ to H_{y} are generated successively upon it being found that the preceding Hₙ does not meet a criterion.

12. A method according to claim 10 wherein the addresses H₁ to H_{y} are generated successively upon it being found that the preceding Hₙ does not meet a criterion.

13. A method of associating look-up table addresses with media access control (MAC) addresses, the method comprising:
receiving a MAC address;
generating a first look-up table address based upon the MAC address, the first look-up address being generated using an algorithm;
determining whether the first look-up table address is occupied; and
if the first look-up table address is occupied, generating a second look-up table address by forming a string having the same number of bits as the MAC address and applying the algorithm to the string.

13. The method of claim 12 and further comprising:
determining whether the second look-up table address is occupied; and
if the second look-up table address is occupied, generating a third look-up table address by forming a second string having the same number of bits as the MAC address and applying the algorithm to the string.

14. The method of claim 13 and further comprising:
determining whether the third look-up table address is occupied; and
if the third look-up table address is occupied, generating a fourth look-up table address by forming a third string having the same number of bits as the MAC address and applying the algorithm to the string.

15. The method of claim 12 wherein determining whether the first look-up table address is occupied comprises determining whether any other MAC address is associated with the first look-up table address such that only one MAC address is associated with any given look-up table address.

16. The method of claim 12 wherein determining whether the first look-up table address is occupied comprises determining whether fewer than n MAC addresses associated with the first look-up table address such that the number of MAC addresses associated with the first look-up table address is less than n, wherein n is an integer greater than one.

17. The method of claim 12 wherein generating a second look-up table address comprises modulating the string with a Walsh code.

18. The method of claim 12 wherein generating a first look-up table address comprises hashing the MAC address with a Cyclic Redundancy Code (CRC).

19. The method of claim 12 and further comprising, if the first look-up table address is not occupied, associating the MAC address with the first look-up table address.

20. The method of claim 19 wherein the step of generating a second look-up table address is not performed if the first look-up table address is not occupied.

21. The method of extracting information related to a media access control (MAC) address, the method comprising:
receiving a MAC address;
generating a first look-up table address by applying an algorithm to the MAC address;
determining whether the first look-up table address is associated with the MAC address;
if the first look-up table address is associated with the MAC address, extracting information related to the MAC address from a look-up table using the first look-up table address;
if the first look-up table address is not associated with the MAC address, generating a second look-up table address by forming a string having the same number of bits as the MAC address and applying the algorithm to the string;
determining whether the second look-up table address is associated with the MAC address; and
if the second look-up table address is associated with the MAC address, extracting information related to the MAC address from the look-up table using the second look-up table address.

22. The method of claim 21 wherein determining whether the first look-up table address is associated with the MAC address comprises examining correspondence data at the first look-up table address in the look-up table.
